(19) United States
(12) Patent Application Publication
(10) Pub. No.: US 2012/0134179 A1
(43) Pub. Date: May 31, 2012

(54) MOSAIC LIGHT GUIDE PLATE STRUCTURE AND BACKLIGHT MODULE

(75) Inventor: Chengwen Que, Shenzhen (CN)

(73) Assignee: SHENZHEN CHINA STAR OPTOELECTRONICS TECHNOLOGY CO., LTD., Shenzhen (CN)

(21) Appl. No.: 13/219,111

(22) Filed: Aug. 26, 2011

(30) Foreign Application Priority Data
Nov. 30, 2010 (CN) 201010571605.8

(51) Int. Cl. F21V 8/00

(52) U.S. Cl. 362/616

(57) ABSTRACT

Disclosed are a mosaic light guide plate structure and a backlight module. The mosaic light guide plate structure comprises at least two light guide plate units. Each of the light guide plate units comprises a first tilt face and a second tilt face with cooperation of at least one light-emitting unit. The first tilt face is positioned at a side of the light guide plate unit. The second tilt face is oppositely positioned to the first tilt face at the other side. The at least one light-emitting unit is positioned under the first tilt face. The present invention assembles adjacent tilt faces to form the light guide plate and changes the direction of light with the tilt faces for solving issues of length limitation for the light guide plate. Accordingly, the mosaic light guide plate structure of the present invention can be suitable for large-scale LCDs and realize local dimming.

### BACKGROUND OF THE INVENTION

1. Field of the Invention

The present invention generally relates to a light guide plate structure and a backlight module, and more particularly to a mosaic light guide plate structure and a backlight module.

2. Description of Prior Art

The LCD (liquid crystal display) is a kind of FPD (flat panel display) which utilizes the property of liquid crystal material for showing images. Comparing with other display, the LCD has advantages of lightening, low driving voltage and low power consumption. The LCD has already become a major product in the market. However, the liquid crystal material in the LCD can not spontaneously generate light and needs the external light source. Therefore, a backlight module must exist in the LCD to provide the needed light source.

In general, the backlight modules can be categorized into two forms of a side light type and a direct light type. In the side light type backlight module, the light is incident from the sides of the light guide plate and emitted toward the top surface of the light guide plate with the special reflection function thereof. The direct light type backlight module does not include any light guide plate. The light of the light source is emitted upwards with the function of the reflection plate at the bottom and the diffuser plate at the top.

Please refer to FIG. 1. FIG. 1 shows a partial sectional diagram of a side light type backlight module according to prior art. The side light type backlight module 90 comprises a back plate 91. The back plate 91 comprises at least one side wall part 911 located at the at least one side border. The center of the back plate 91 carries a light guide plate 92. An optical film set 93 is installed above the light guide plate 92. A housing 94 covers the periphery of the back plate 91 and fixes the optical film set 93 and the light guide plate 92 from top to bottom for completing the side light type backlight module 90. Besides, a light-emitting unit 95 is positioned at the inner surface of the at least one side wall part 911 in the back plate 91 of the side light type backlight module 90. The light-emitting unit 95 can be a LED lighting element and the light direction of light-emitting unit 95 is directed toward the light guide plate 92. Generally, the light-emitting unit 95 is fixed to the side wall part 911 with screws, thermal tapes or etc. Furthermore, a liquid crystal panel 80 (indicated by the phantom line) overlays on the side light type backlight module 90 and a shell 70 (indicated by the phantom line) is spliced to cover and fix the liquid crystal panel 80 and the side light type backlight module 90 for assembling a LCD (not shown).

However, as the side light type backlight module 90 is applied for large-scale LCDs or TVs (such as larger than 42 inches), the sizes of the backlight module 90 and the light guide plate 92 have to become larger in accordance with the larger display area of the large-scale LCDs. Because the light is emitted from the side locating the light-emitting unit 95 and the intensity of light must gradually become weaker with certain distance propagation. Therefore, the brightness of the light reflected upwards by the light guide plate 92 wherein is relatively farther to the light-emitting unit 95 is lower (The center of the light guide plate is relatively farther in case that light sources are located at two sides; one side of the light guide plate is relatively farther in case that light sources are merely located at the opposite side) and results in non-uniformity of the entire brightness of the light guide plate 92.

Therefore, the aforementioned the backlight module 90 is not suitable for applying in the large-scale LCDs. The direct light type backlight module needs a certain space for mixing light and is disadvantaged for thin package of the large-scale LCDs.

Besides, the direct light type backlight module can realize a local dimming by controlling the LED lamps in array individually. The benefits of local dimming are to save power consumption and promote picture quality. However, the backlight module with the light guide plate according to prior art can merely provide synchronous dimming for entire areas. Therefore, such local dimming cannot be achieved.

Consequently, there is a need to provide a mosaic light guide plate structure and a backlight module to solve the existing issues of prior art.

### SUMMARY OF THE INVENTION

An objective of the present invention is to provide a mosaic light guide plate structure and backlight module. By splicing a first tilt face and a second tilt face of the adjacent light guide plate units to form the mosaic light guide plate and changing the direction of light from a light-emitting unit with the first tilt face for keeping the uniformity of the brightness of the light guide plate, the area of the light guide plate has no limitation and issues of length limitation for the light guide plate are solved in advance. Therefore, the mosaic light guide plate structure of the present invention can be suitable for large-scale LCDs.

Another objective of the present invention is to provide a mosaic light guide plate structure and a backlight module. By light emitting control to the respective light guide plate units, the local dimming can be achieved.

Another objective of the present invention is to provide a mosaic light guide plate structure and a backlight module. By design of the tilt faces, light guide plate units can be easily spliced to form a level and seamless backlight structure.

For realizing the aforesaid objectives, the present invention provides a mosaic light guide plate structure, utilized in a backlight module, characterized in that the mosaic light guide plate structure comprises:

at least two light guide plate units, and each of the light guide plate units comprises:
a first tilt face, positioned at a side of the light guide plate unit; and
a second tilt face, oppositely positioned to the first tilt face at the other side of the light guide plate unit; and
at least one light incident zone, formed in the bottom of the light guide plate unit and corresponding to the first tilt face, wherein light is incident into the light guide plate unit and toward the first tilt face from the light incident zone, and the light is reflected by the first tilt face and turned toward the interior of the light guide plate unit;

wherein each of the light guide plate units is spliced with another adjacent light guide plate unit with the first tilt face or the second tilt face to form the mosaic light guide plate structure.

In one embodiment of the present invention, tilt angles of the first tilt face and the second tilt face are between 30 degrees and 60 degrees and preferably to be 45 degrees.

In one embodiment of the present invention, at least one of the first tilt face and the second tilt face comprises a reflection layer; two straight sides of the light guide plate unit comprises a reflection layer respectively; and the bottom of the light guide plate unit except the light incident zone comprises a reflection layer.

In one embodiment of the present invention, the light guide plate unit is fixed on a back plate of the backlight module by screws, fastener or glue, and the back plate comprises at least one accommodation unit in accordance with the light incident zone for accommodating at least one light-emitting unit to provide the light.

In one embodiment of the present invention, at least one accommodation unit at the bottom of the light guide plate unit is formed in accordance with the light incident zone under the first tilt face for accommodating at least one light-emitting unit to provide the light.

For realizing the aforesaid another objectives, the present invention provides backlight module with the mosaic light guide plate structure, comprising a mosaic light guide plate structure, at least one light-emitting unit, and a back plate, and the mosaic light guide plate structure comprises at least two light guide plate units and each of the light guide plate units comprises:

a mosaic light guide plate structure, at least one light-emitting unit, and a back plate, and the mosaic light guide plate structure comprises at least two light guide plate units and each of the light guide plate units comprises:
a first tilt face, positioned at a side of the light guide plate unit;
a second tilt face, oppositely positioned to the first tilt face at the other side of the light guide plate unit; and
at least one light incident zone, formed in the bottom of the light guide plate unit and corresponding to the first tilt face, wherein light generated by the at least one light-emitting unit is incident into the light guide plate unit and toward the first tilt face from the light incident zone, and the light is reflected by the first tilt face and turned toward the interior of the light guide plate unit;

wherein each of the light guide plate units is spliced with another adjacent light guide plate unit with the first tilt face or the second tilt face to form the mosaic light guide plate structure and the mosaic light guide plate structure is fixed on the back plate.

The present invention assembles the first tilt face or/and the second tilt face of the adjacent light guide plate units to form the light guide plate. The direction of light is changed with the first tilt face for ensuring the uniformity of the brightness of the light guide plate. Accordingly, the mosaic light guide plate structure can be utilized for large-scale LCDs to realize the thin package of the large-scale LCDs. Besides, the local dimming can be achieved by light emitting control to the respective light guide plate units.

### BRIEF DESCRIPTION OF THE DRAWINGS

FIG. 1 shows a partial sectional diagram of a side light type backlight module according to prior art.

FIG. 2 shows a partial three dimensional view diagram of a mosaic light guide plate structure according to a first embodiment of the present invention.

FIG. 3 shows a partial sectional diagram of a mosaic light guide plate structure according to the first embodiment of the present invention.

FIG. 4A shows a top view diagram of a mosaic light guide plate structure according to the first embodiment of the present invention.

FIG. 4B shows a top view diagram of another mosaic light guide plate structure according to the first embodiment of the present invention.

FIG. 5 shows a partial sectional diagram of a mosaic light guide plate structure according to a second embodiment of the present invention.

FIG. 6 shows a partial sectional diagram of a mosaic light guide plate structure according to a third embodiment of the present invention.

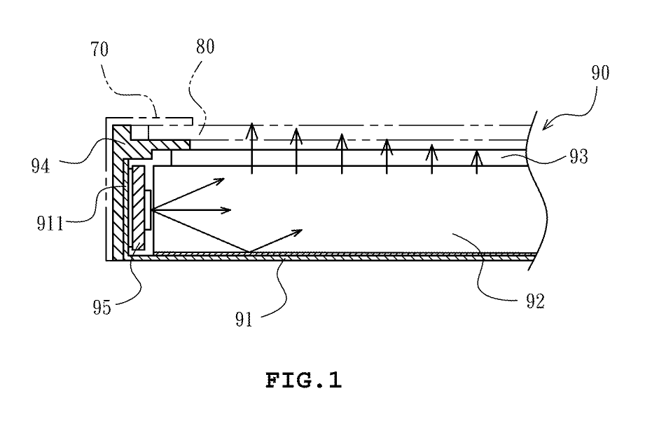

### DETAILED DESCRIPTION OF THE INVENTION

For a better understanding the aforementioned content of the present invention, preferable embodiments are illustrated in accordance with the attached figures for further explanation:

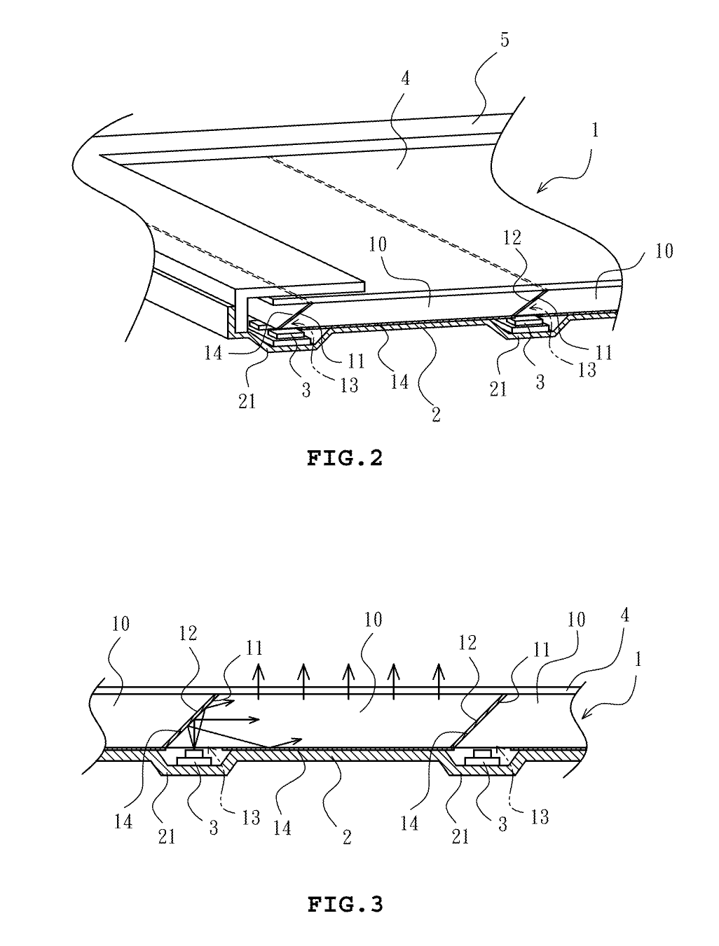

Please refer to FIG. 2 and FIG. 3. FIG. 2 shows a partial three dimensional view diagram of a mosaic light guide plate structure according to a first embodiment of the present invention; FIG. 3 shows a partial sectional diagram of a mosaic light guide plate structure according to the first embodiment of the present invention. As shown in FIG. 2 and FIG. 3, a mosaic light guide plate structure 1 is utilized in a backlight module (not shown). The mosaic light guide plate structure 1 comprises at least two light guide plate units 10. Each of the light guide plate units 10 comprises a first tilt face 11, a second tilt face 12 and at least one light incident zone 13. The first tilt face 11 is positioned at a side of the light guide plate unit 10; the second tilt face 12 is oppositely positioned to the first tilt face 11 at the other side of the light guide plate unit 10; the at least one light incident zone 13 formed under the first tilt face 11, i.e. an space corresponding to first tilt face 11 in the bottom of the light guide plate unit 10. Light is incident into the light guide plate unit 10 and toward the first tilt face 11 from the light incident zone 13. The light is reflected by the first tilt face 11 and then turned toward the interior of the light guide plate unit 10.

As shown in FIG. 2 and FIG. 3, each of the light guide plate units 10 is spliced with another adjacent light guide plate unit 10 with the first tilt face 11 or/and the second tilt face 12 to form the mosaic light guide plate structure 1. Meanwhile, the light guide plate unit 10 is fixed on a back plate 2 of the backlight module. The back plate 2 comprises at least one accommodation unit 21 in accordance with the light incident zone 13 for accommodating at least one light-emitting unit 3 to provide the light. Meanwhile, the at least one accommodation unit 21 extrudes outwards from the back plate 2. Hereby, the volume of the backlight module can be reduced. Moreover, the whole light-emitting unit 3 can be closer to the exterior of the back plate 2 and the heat dissipation efficiency of the light-emitting unit 3 can be improved. Besides, as shown in FIG. 2, an optical film set 4 is installed above the mosaic light guide plate structure 1. A housing 5 covers the periphery of the back plate 91 and fixes the optical film set 4 and the mosaic light guide plate structure 1 for completing the backlight module.

Preferably, reflection layers 14 can be selectively formed at lots of different positions to intensify the reflection effect of the light guide plate unit 10. For example, the first tilt face 11 comprises a reflection layer 14 formed thereon; the second tilt face 12 comprises a reflection layer 14 formed thereon; the reflection layer can be a reflection film or a reflection coating layer spread on the first tilt face 11 and/or the second tilt face 12. The aforesaid reflection film or the reflection coating layer can be manufacture by with high reflectivity material, such as Argentum, Aluminium, Aurum, Chromium, Copper, Indium, Iridium, Niccolum, Platinum, Rhenium, Rhodium, Stannum, Tantalum, Wolfram, Cobaltum, the alloy of the aforesaid materials, white reflection paint of yellowing resistance, heat resisting, or any combination of the aforesaid materials to reflect the light. Two other sides of the light guide plate unit 10 which are straight comprises a reflection layer (not shown) formed thereon respectively; and the bottom of the light guide plate unit 10 except the light incident zone 13 comprises a reflection layer formed thereon. The reflection layer can be a reflection film or coated reflection material.

As shown in FIG. 3, the tilt angle of the first tilt face 11 is preferably 45 degrees. When the light-emitting unit 3 is lighted up, the light of the light-emitting unit 3 penetrates the light incident zone 13 upwards to illuminate the interior of the light guide plate unit 10. The partial of the light is incident onto the first tilt face 11. Because the first tilt face 11 is tilted and comprises a reflection layer, the light is reflected here. FIG. 3 shows that as considering the light generated by the light-emitting unit 3, after the split light beams with different directions are reflected by the first tilt face 11, then the split light beams are approximately turned toward the interior of the light guide plate unit. Hence, the direction of the light is changed and becomes uniformed. Because the periphery and the bottom of the light guide plate unit 10 are mostly covered by the reflection layers 14. The ultimate uniformed light propagates upwards to provide the backlight function.

Furthermore, the tilt angles of the first tilt face 11 and the second tilt face 12 can be between 30 degrees and 60 degrees and preferably to be 45 degrees. However, the objective of the present invention is to change the direction of the light by the tilt face design, therefore, the tilt angles of the first tilt face 11 and the second tilt face 12 do not have limitation. The user can adjust the tilt angles for meeting demands according to the real circumstances. Besides, the reflection layer 14, such as reflection film can be merely formed on the surface of the first tilt face 11 or the second tilt face 12. Alternatively, the reflection layer 14 can be lined between the first tilt face 11 and the second tilt face 12.

Furthermore, the splice ways among the light guide plate units 10 are not limited in the present invention. The light guide plate units 10 can be spliced by screws, fastener or glue. Alternatively, the light guide plate units 10 can be unfixedly spliced one another but each of the light guide plate units 10 can be fixed on a back plate 2 of the backlight module by screws, fastener or glue (FIG. 2 and FIG. 3). With such tilt face design for the light guide plate unit 10 of the present invention, the light guide plate units 10 can be easily spliced to form a level and seamless backlight structure.

Moreover, the amount and the arrangement of the light-emitting units 3 can be in ways of many independent units or arranged as light bars. The light guide plate unit 10 also can be design with kinds of sizes as long as a proper distance is maintained between the first tilt face 11 and the second tilt face 12 to ensure the ultimate upward light keeps uniformed. Besides, the distance between the two other sides of the light guide plate unit 10 which are straight is related with the amount and the arrangement of the light-emitting units 3. The user can do the set up according to the real demands.

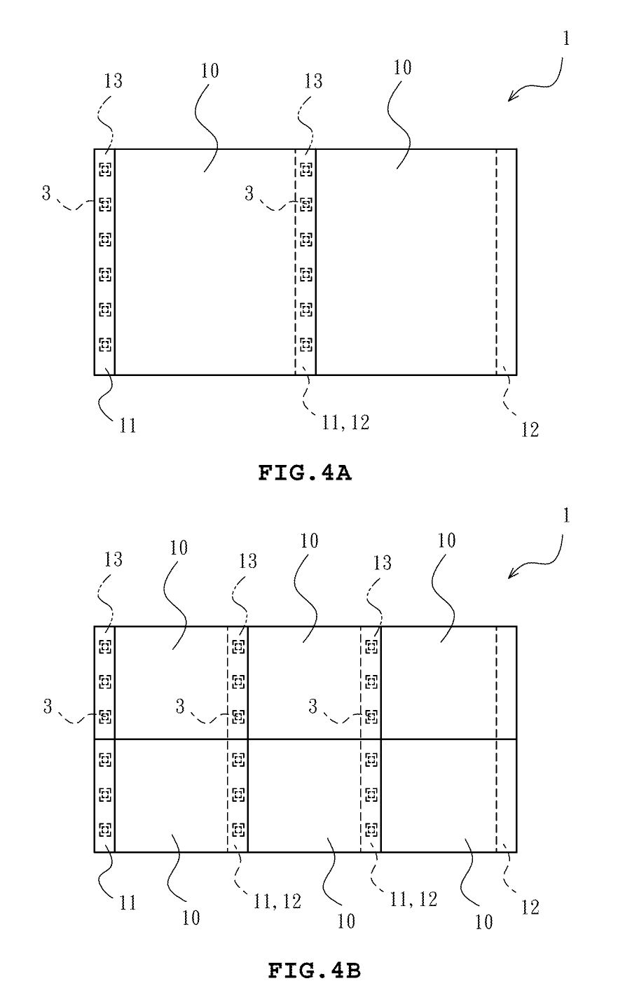

Please refer to FIG. 4A and FIG. 4B. FIG. 4A shows a top view diagram of a mosaic light guide plate structure according to the first embodiment of the present invention; FIG. 4B shows a top view diagram of another mosaic light guide plate structure according to the first embodiment of the present invention. As shown in FIG. 4A and FIG. 4B, the amount and the arrangement of the light guide plate unit 10 of the present invention can be arranged in alignment (as shown in FIG. 4A). Alternatively, the light guide plate unit 10 can be arranged in array (as shown in FIG. 4B). The user can do flexible adjustment according to the size of the backlight module needed for the LCD. Because the mosaic light guide plate structure 1 is formed by splice. The size of the mosaic light guide plate structure 1 can be enlarged without limitations to adapt to large-scale LCDs or Xtra Large-scale LCDs. Moreover, the mosaic light guide plate structure 1 of the present invention can realize the local dimming backlight by light emitting control to every light guide plate units 10. Accordingly, the power consumption can be reduced and the picture quality can be promoted.

In conclusion, the mosaic light guide plate structure 1 of the present invention is achieving the effectiveness below:

With the mosaic structure, the present invention can be utilized for large-scale LCDs and realize the thin package of the large-scale LCDs.

By the light emitting control to the respective light guide plate units, the local dimming can be realized.

By the tilt face design, each of the light guide plate units 10 can be easily spliced to form a level and seamless backlight structure.

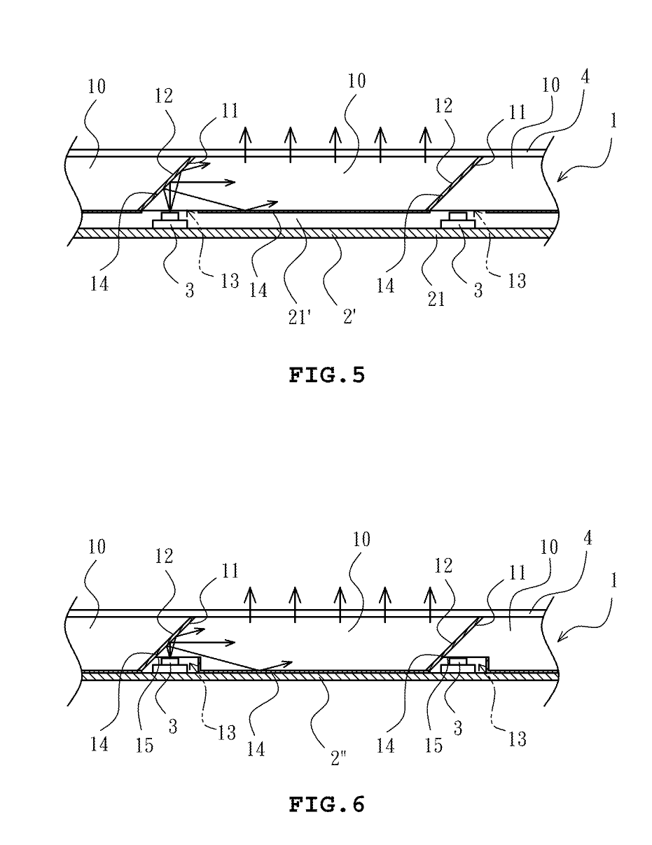

Please refer to FIG. 5. FIG. 5 shows a partial sectional diagram of a mosaic light guide plate structure according to a second embodiment of the present invention. The mosaic light guide plate structure 1 in the second embodiment of the present invention is similar with the mosaic light guide plate structure 1 in the first embodiment. Therefore, the same indicators and names are followed. The difference is: the back plate 2′ in the second embodiment of the present invention does not comprise the accommodation unit 21 extruding outwards therefrom in the first embodiment. The surface of the back plate 2′ is level and the light-emitting unit 3 is accommodated in at least one accommodation unit 21′ between the back plate 2′ and the light guide plate unit 10. The at least one accommodation unit 21 is utilized for accommodating the light-emitting unit 3 to provide the light.

Please refer to FIG. 6. FIG. 6 shows a partial sectional diagram of a mosaic light guide plate structure according to a third embodiment of the present invention. The mosaic light guide plate structure 1 in the third embodiment of the present invention is similar with the mosaic light guide plate structures 1 in the first and second embodiments. Therefore, the same indicators and names are followed. The difference is: the back plate 2″ does not comprise the accommodation unit 21, 21′. Instead, at least one accommodation unit 15 at the bottom of the light guide plate unit 10 is formed in accordance with the light incident zone 13 under the first tilt face 11 for accommodating at least one light-emitting unit 3 to provide the light. Hereby, the thin package of the backlight module.

In conclusion, comparing with the side light type backlight module of prior art which cannot be utilized for the large-scale LCDs, and cannot achieve local dimming, by splicing the first tilt face 11 or/and the second tilt face 12 of the adjacent light guide plate units 10 to form the mosaic light guide plate 1 and changing the direction of light from the light-emitting unit 3 with the first tilt face, accordingly, the uniformity of the brightness of back light in the present invention can be ensured. The mosaic light guide plate 1 can be utilized for large-scale LCDs and can realize the thin package of the large-scale LCDs. Furthermore, the local dimming can be achieved by light emitting control to the respective light guide plate units.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A mosaic light guide plate structure, utilized in a backlight module, characterized in that the mosaic light guide plate structure comprises:
at least two light guide plate units, and each of the light guide plate units comprises:
a first tilt face, positioned at a side of the light guide plate unit and the tilt angle of the first tilt face is 45 degrees; and
a second tilt face, oppositely positioned to the first tilt face at the other side of the light guide plate unit and the tilt angle of the second tilt face is 45 degrees; and
at least one light incident zone, formed in the bottom of the light guide plate unit and corresponding to the first tilt face, wherein light is incident into the light guide plate unit and toward the first tilt face from the light incident zone, and the light is reflected by the first tilt face and turned toward the interior of the light guide plate unit;
wherein each of the light guide plate units is spliced with another adjacent light guide plate unit with the first tilt face or the second tilt face to form the mosaic light guide plate structure, and at least one of the first tilt face and the second tilt face comprises a reflection layer, and two straight sides of the light guide plate unit comprises a reflection layer respectively, and the bottom of the light guide plate unit except the light incident zone comprises a reflection layer.

2. The mosaic light guide plate structure of claim 1, characterized in that the light guide plate unit is fixed on a back plate of the backlight module, and the back plate comprises at least one accommodation unit in accordance with the light incident zone for accommodating at least one light-emitting unit to provide the light.

3. The mosaic light guide plate structure of claim 1, characterized in that at least one accommodation unit at the bottom of the light guide plate unit is formed in accordance with the light incident zone under the first tilt face for accommodating at least one light-emitting unit to provide the light.

4. A mosaic light guide plate structure, utilized in a backlight module, characterized in that the mosaic light guide plate structure comprises:
at least two light guide plate units, and each of the light guide plate units comprises:
a first tilt face, positioned at a side of the light guide plate unit; and
a second tilt face, oppositely positioned to the first tilt face at the other side of the light guide plate unit; and
at least one light incident zone, formed in the bottom of the light guide plate unit and corresponding to the first tilt face, wherein light is incident into the light guide plate unit and toward the first tilt face from the light incident zone, and the light is reflected by the first tilt face and turned toward the interior of the light guide plate unit;
wherein each of the light guide plate units is spliced with another adjacent light guide plate unit with the first tilt face or the second tilt face to form the mosaic light guide plate structure.

5. The mosaic light guide plate structure of claim 4, characterized in that tilt angles of the first tilt face and the second tilt face are between 30 degrees and 60 degrees.

6. The mosaic light guide plate structure of claim 4, characterized in that tilt angles of the first tilt face and the second tilt face are 45 degrees.

7. The mosaic light guide plate structure of claim 4, characterized in that at least one of the first tilt face and the second tilt face comprises a reflection layer.

8. The mosaic light guide plate structure of claim 4, characterized in that two straight sides of the light guide plate unit comprises a reflection layer respectively.

9. The mosaic light guide plate structure of claim 4, characterized in that the bottom of the light guide plate unit except the light incident zone comprises a reflection layer.

10. The mosaic light guide plate structure of claim 4, characterized in that the light guide plate unit is fixed on a back plate of the backlight module, and the back plate comprises at least one accommodation unit in accordance with the light incident zone for accommodating at least one light-emitting unit to provide the light.

11. The mosaic light guide plate structure of claim 4, characterized in that at least one accommodation unit at the bottom of the light guide plate unit is formed in accordance with the light incident zone under the first tilt face for accommodating at least one light-emitting unit to provide the light.

12. A backlight module with a mosaic light guide plate structure, characterized in that the backlight module comprises:
a mosaic light guide plate structure, at least one light-emitting unit, and a back plate, and the mosaic light guide plate structure comprises at least two light guide plate units and each of the light guide plate units comprises:
a first tilt face, positioned at a side of the light guide plate unit;
a second tilt face, oppositely positioned to the first tilt face at the other side of the light guide plate unit; and
at least one light incident zone, formed in the bottom of the light guide plate unit and corresponding to the first tilt face, wherein light generated by the at least one light-emitting unit is incident into the light guide plate unit and toward the first tilt face from the light incident zone, and the light is reflected by the first tilt face and turned toward the interior of the light guide plate unit;
wherein each of the light guide plate units is spliced with another adjacent light guide plate unit with the first tilt face or the second tilt face to form the mosaic light guide plate structure and the mosaic light guide plate structure is fixed on the back plate.

13. The backlight module with the mosaic light guide plate structure of claim 12, characterized in that tilt angles of the first tilt face and the second tilt face are between 30 degrees and 60 degrees.

14. The backlight module with the mosaic light guide plate structure of claim 12, characterized in that tilt angles of the first tilt face and the second tilt face are 45 degrees.

15. The backlight module with the mosaic light guide plate structure of claim 12, characterized in that at least one of the first tilt face and the second tilt face comprises a reflection layer.

16. The backlight module with the mosaic light guide plate structure of claim 12, characterized in that two straight sides of the light guide plate unit comprises a reflection layer respectively.

17. The backlight module with the mosaic light guide plate structure of claim 12, characterized in that the bottom of the light guide plate unit except the light incident zone comprises a reflection layer.

18. The backlight module with the mosaic light guide plate structure of claim 12, characterized in that the light guide plate unit is fixed on a back plate of the backlight module, and the back plate comprises at least one accommodation unit in accordance with the light incident zone for accommodating at least one light-emitting unit to provide the light.

19. The backlight module with the mosaic light guide plate structure of claim 12, characterized in that at least one accommodation unit at the bottom of the light guide plate unit is formed in accordance with the light incident zone under the first tilt face for accommodating at least one light-emitting unit to provide the light.
